(19) United States
(12) Patent Application Publication
(10) Pub. No.: US 2016/0075118 A1
(43) Pub. Date: Mar. 17, 2016

(54) TEXTURED SELF-ADHESIVE SURFACE COVERING

(71) Applicant: TEMPAINT, LLC, Woodinville, WA (US)

(72) Inventors: Lane Kleppen, Seattle, WA (US); Travis Rager, Mill Creek, WA (US)

(73) Assignee: TEMPAINT, LLC, Woodinville, WA (US)

(21) Appl. No.: 14/728,856

(22) Filed: Jun. 2, 2015

Related U.S. Application Data
(60) Provisional application No. 62/049,635, filed on Sep. 12, 2014.

(51) Int. Cl. B32B 33/00; B32B 3/30; B32B 27/30; B32B 27/28; B32B 38/14; B32B 7/12; B32B 37/12; B32B 37/00; B32B 38/00; B29C 65/00; B32B 7/06

(52) U.S. Cl. CPC B32B 33/00; B29C 65/002; B29C 66/45; B29C 66/028; B32B 3/30; B32B 27/304; B32B 27/28; B32B 7/06; B32B 7/12; B32B 37/12; B32B 37/0038; B32B 38/0012; B32B 38/14; B29C 66/0324; B29K 2627/06

(57) ABSTRACT

A removable surface covering comprising a base material layer having a first surface and a second surface, the first surface having a colored ink applied thereon, a transparent vinyl layer having an outer surface and an inner surface, the inner surface applied onto the first surface of the base material layer, the outer surface having a textured paint-like surface, a release layer capable of having one or more shapes and patterns printed thereon for cutting and/or trimming, the paper being at least one of a wax-paper, a non-stick paper and a release-paper, and a pressure-sensitive adhesive disposed between the second surface of the base material layer and the release layer, the adhesive being a water-based acrylic.

### CROSS-REFERENCE TO RELATED APPLICATION

This application claims the benefit of priority to U.S. Provisional Application No. 62/049,635, entitled “Temporary Self-Adhesive Textured Surface Covering” filed Sep. 12, 2014, the entire contents of which are incorporated herein by reference.

### FIELD

The present disclosure relates generally to the field of wallpaper coverings, and in particular but not exclusively, relates to a self-adhesive wallpaper covering for the enhancement of walls, living spaces and decorative surfaces.

### BACKGROUND

Paint and paint-like coatings are commonly used to decorate living spaces, work environments and the surfaces of decorative objects and to cover blemishes or surface imperfections in such locations. In many cases, it is difficult, time-consuming and expensive to remove or change wall-coverings or paint in locations such as those that are owned, controlled or regulated by others. Examples of such locations include apartment complexes and office spaces where the ability to paint or to make modifications that may be permanent in nature is restricted by rules set by landlords or rental leasing companies. This is commonly the case in university or college campus housing as well as in many residential and commercial rental properties.

In work environments, employers may dissuade or outright prohibit employees from making permanent changes to their work environments, particularly those involving the addition of paint or other materials to walls or other locations within a work environment. Frequently, personal changes to a work environment such as in offices or cubicles are usually banned for painting purposes for various reasons, including the desire of an employer to preserve some degree of uniformity in a work environment irrespective of a particular employee's need or desire for some element of creativity.

In other instances, it is often desirable to cover surfaces on a temporary basis simply to alter color, appearance or finish. Up to the present time, however, the only available alternatives that are not paint have been limited to other permanent solutions such as textured wallpaper. In addition to its use on a permanent basis, paint has functional draw backs such as the taping, masking and drying of painted areas, the release of undesirable fumes, the effort to clean-up after a surface or area has been painted, and the time committed to painting and related clean-up tasks. The painting of a surface can also result in inadequate coverage for all areas of a surface, such as areas with imperfections (e.g., edges, grooves, cracks, etc.), and most certainly prevents a surface from being restored to its original state, which may be necessary upon termination of a lease or the resale of a product (e.g., a white refrigerator, etc.). On the other hand, the use of textured wallpaper can produce unappealing overlapping sections and can frequently cause the removal of portions of the paint or other coating on the original underlying surface when such wallpaper is itself removed.

Thus, there is a significant need for a self-adhesive paint-imitating surface covering solution that be applied in an easy, temporary manner over a surface of any size and shape that can also be repositioned and removed while preserving the original condition or state of the underlying surface. There is also a need for a temporary paint-imitating surface covering solution that can be applied as a layer to areas of varying types, including areas with imperfections, to produce renderings on finished surfaces that are both even and paint-like in appearance.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a side view of a textured wallpaper surface covering in an embodiment.

FIG. 2 is a perspective view of a textured wallpaper surface covering in an embodiment.

FIG. 3 is a flow chart illustrating a method for making a textured wallpaper surface covering in an embodiment.

### DETAILED DESCRIPTION

In the description to follow, various embodiments will be described, and specific configurations will be set forth. Numerous and specific details are given to provide an understanding of these embodiments. The aspects disclosed herein can be practiced without one or more of the specific details, or with other methods, components, or systems. In other instances, structures or operations are not shown or described in detail to avoid obscuring relevant inventive aspects.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification do not necessarily refer to the same embodiment. Furthermore, the particular features, structures, or characteristics may be combined in any suitable manner in one or more embodiments.

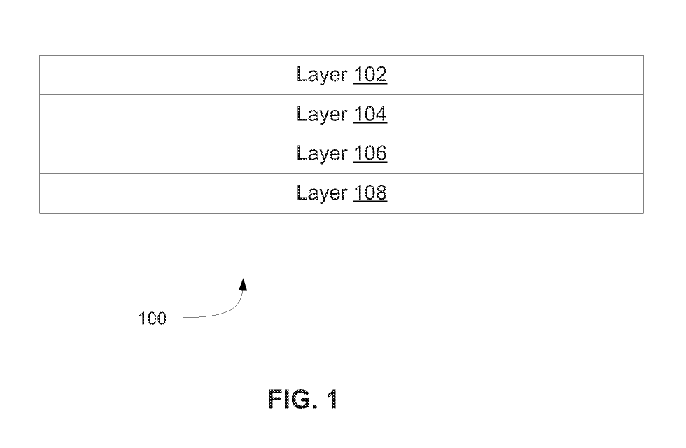

FIG. 1 is an illustration of the cross-sectional structure of a textured wallpaper surface covering 100 in an embodiment. In the illustrated embodiment, the surface covering 100 is comprised of several layers. A transparent vinyl layer 102 is shown on the upper most level of the textured wallpaper surface covering 100 which, in an embodiment, is comprised of polyvinyl chloride (PVC). In alternative embodiments, the vinyl layer 102 is comprised of polyethylene or polypropylene. Beneath the transparent vinyl layer 102 is a base material layer 104 that is comprised of a vinyl material, a plastic material, a paper material or a cloth material in varying embodiments. The base material layer 104 is provided in alternative embodiments in either a dark color (e.g., black) or a light color (e.g., white, beige, tan, aqua blue, etc.). In the preferred embodiment, the base material layer 104 has a colored ink applied to its upper surface based on the preference of a manufacturer, a distributor, or a customer. The base material layer 104 in the preferred embodiment is greater than 0.08 millimeters in thickness and preferably about 0.12 millimeters in thickness. The finished thickness of the wallpaper surface covering 100 is nominally 0.15 millimeters plus applicable manufacturing variances or tolerances that are generally in the range of +/−0.03 millimeters.

The transparent vinyl layer 102 is applied onto the upper surface of the base material layer 104 using a lamination process in an embodiment. Although a lamination process is preferred, alternative processes for binding the vinyl layer 102 to the base material layer 104 can be used in alternative embodiments. A pressure sensitive adhesive is applied to a lower surface of the base material layer 104. This pressure sensitive adhesive forms an adhesive layer 106 that is disposed between the lower surface of the base material 104 and a release paper layer 108. The release paper layer 108 can include one or more shapes and patterns which are printed on this layer for use in cutting or trimming various structures, patterns or shapes as desired by an end user. The release paper layer 108 in alternative embodiments is comprised of wax paper, nonstick paper or release paper. In different embodiments, alternative forms of release materials can be used provided the unique adhesive quality of the pressure-sensitive adhesive used in the adhesive layer 106 is preserved. In one specific embodiment, the adhesive layer 106 is comprised of a water based acrylic having a thickness range in a preferred embodiment from 0.02 millimeters to 0.04 millimeters. This preferred thickness range for the adhesive layer 106 ensures that it will not lose its adhesive property over an extended period of time (e.g., between one to five years) while also enabling the wallpaper surface covering 100 to be removed or repositioned with the removal of little to none of the underlying paint on the surface to which the surface covering 100 has been applied. The transparent vinyl layer 102 which is applied onto the base material layer 104 has on its outer surface in one embodiment a textured paint-like surface formed from a process that transfers a form of textured surface onto materials of the type used in the transparent vinyl layer 102. After transfer of the textured surface, the wallpaper surface covering 100 appears as if it has been painted onto a surface with a texture that is similar in appearance to the textures common on painted surfaces. In alternative embodiments, the transparent vinyl layer 102 has alternative textures imposed on it resulting in the production of a wallpaper surface covering 100 that appears to have a matte paint-like finish, such as a roller finish, a brush finish, a spray finish or a sponge finish.

The adhesive layer 106 is applied such that the thickness is sufficient to achieve a desired degree of adhesion to a surface (e.g., a wall or an object surface) without causing the removal of the underlying paint on a wall or surface. For lighter colored hues, the base material layer 104 is comprised of a light or white base material. For darker colored hues such as black, dark blue or dark red, the base material is in a preferred embodiment black in color. The use of a white base material or a black base material onto which colored ink is applied prevents the visual appearance of overlapping wallpaper regions after application of a wallpaper surface covering. Specifically, when using a white base material in the base material layer 104 with lighter colored ink applied to the upper surface of the base material layer 104, any overlapping of wallpaper surface covering material that occurs will not produce visually darker hues (i.e., distinctly darker lines which visibly mark the end of one section of material when laid upon a different section of material) in an overlapped region. This optical property is used to preserve the appearance of consistency in overlapping regions and to avoid the appearance of darker lines or zones when they overlap as is common in conventional wallpaper coverings. In addition, the use of a transparent vinyl layer 102 prevents the run off onto the hands of users of the colored ink which is applied to the base material layer 104.

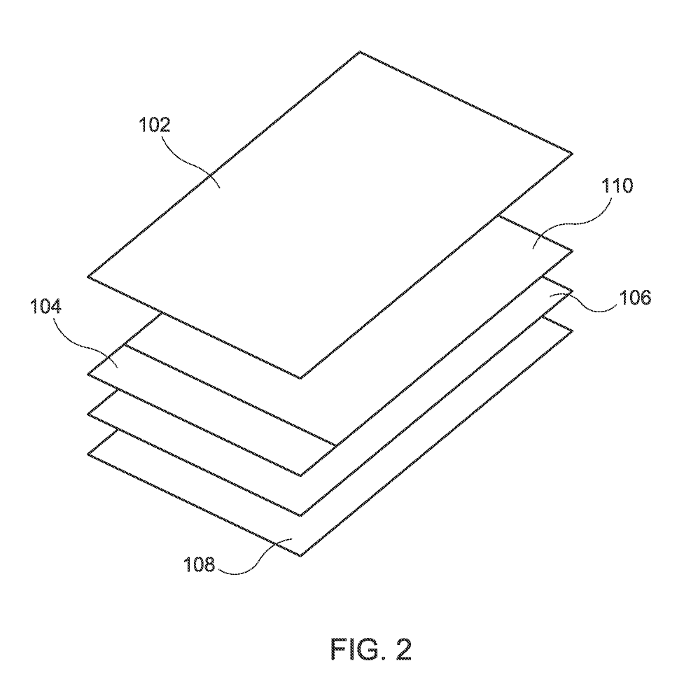

FIG. 2 is a perspective view of each layer in the wallpaper surface covering 100 in an embodiment. In the illustrated embodiment, the transparent vinyl layer 102 is shown applied onto an upper surface of the base material layer 104 on which a colored ink has been applied 110. A variety of colored inks can be applied to the base material layer 104 to achieve a desired finish. As discussed above, for black, dark red, dark blue or darker hues, a black base material is used for the base material layer 104. For lighter colors, a white colored base material 104 is used. The base material layer 104 is shown applied onto a release paper layer 108 with use of a pressure sensitive adhesive. This pressure sensitive adhesive is applied as an adhesive layer 106 that is disposed between the lower face of the base material layer 104 and the upper surface of the release paper layer 108.

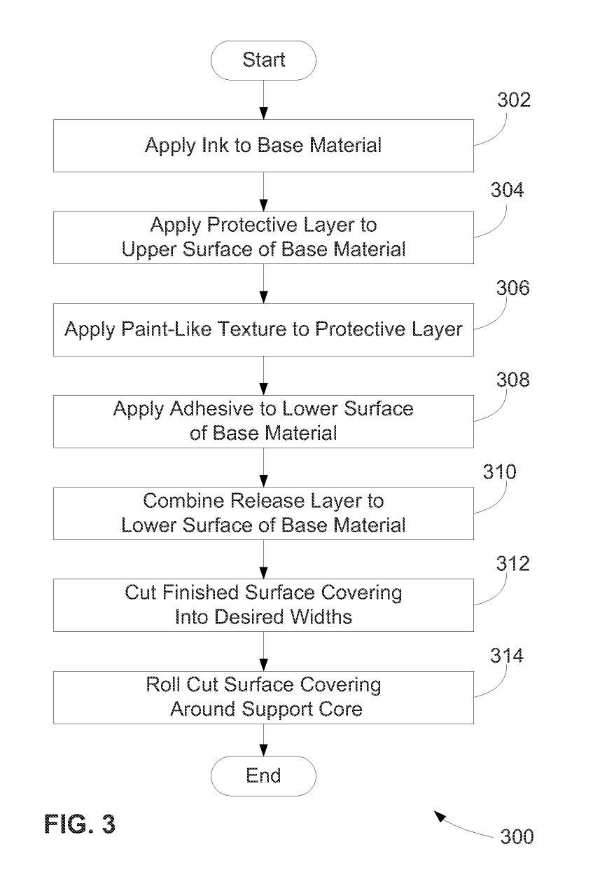

FIG. 3 is a flowchart illustrating a process 300 for making a wallpaper surface covering with a textured surface in an embodiment. In this illustrated embodiment, a colored ink is applied to a base material, as shown at step 302. The colored ink is applied to an upper surface of the base material without leaking or the addition of colored ink to a lower surface of the base material. After application of the ink to the base material, a protective layer of transparent vinyl material is applied to the upper surface of the base material, as shown at step 304. A paint-like texture is then transferred from one or more extruders and applied to the protective layer of the wallpaper surface covering, as shown at step 306. One or more extruders are then used to transfer and impose upon the protective layer a paint-like appearance with a desired textured finish. Various forms of textured or matte finishes can be applied, such as a roller finish, a brush finish, a spray finish and a sponge finish.

After application of the paint-like texture to the protective layer, an adhesive layer is applied to the lower surface of the base material, as shown at step 308. A release paper is then combined to the lower surface of the base material layer using the adhesive layer, as shown at step 310, to produce a finished wallpaper covering. The release paper includes in alternative embodiments various forms of printed material including text and photos such as measuring grids, application instructions, application photos, and shapes or patterns for cutting and trimming (e.g., butterflies, stars, or diamonds). The finished wallpaper covering is then cut into desired widths (e.g., an American Standard roll of wallpaper, a 6-inch strip for applying wall borders, etc.), as shown at step 312, which can then be rolled onto a support core, as shown at step 314, for convenient packaging and shipment.

In applying the wallpaper surface covering, a user peels away a 2 to 6 inch segment of the release paper. The wallpaper surface covering is then aligned and the exposed adhesive portion is placed in contact with an application surface (e.g., a wall or ceiling). The release paper is removed a small portion at a time by peeling it away from the adhesive layer and afterwards the user applies consistent pressure to the wallpaper surface covering on the application surface using methodical sweeping motions across its surface to reduce or eliminate air trapped between the application surface and the wallpaper surface covering. Once a portion of an application surface has been covered, added portions of the wallpaper surface covering can be provided alongside or slightly overlapping the initial portion of the wallpaper surface covering. After coverage of the desired portions or areas of an application surface, the user can use a cutting edge (e.g., a utility knife or a pair of scissors, etc.) to trim any excess portions of the wallpaper surface covering from select areas (e.g., unintentionally covered areas, etc.). When no longer needed or desired, the user can then remove the wallpaper surface covering from an application surface by slowly peeling away a corner of the surface covering and then gently pulling back and alongside the entirety of the wallpaper surface covering.

Although specific embodiments have been illustrated and described herein, it will be appreciated by those of ordinary skill in the art that a wide variety of alternate and/or equivalent implementations may be substituted for the specific embodiments shown and described without departing from the scope of the present disclosure. This application is intended to cover any adaptations or variations of the embodiments discussed herein.

What is claimed is:

1. A removable surface covering comprising:
a base material layer having a first surface and a second surface, the first surface having a colored ink applied thereon;
a transparent vinyl layer having an outer surface and an inner surface, the inner surface applied onto the first surface of the base material layer, the outer surface having a textured paint-like surface;
a release layer capable of having one or more shapes and patterns printed thereon for cutting and/or trimming, the paper being at least one of a wax-paper, a non-stick paper and a release-paper; and
a pressure-sensitive adhesive disposed between the second surface of the base material layer and the release layer, the adhesive being a water-based acrylic having a thickness range from 0.02 mm to 0.04 mm.

2. The removable surface covering of claim 1 wherein the release layer is comprised of material having descriptive content, the descriptive content being at least one of a measuring grid, textual application instructions and application photos.

3. The removable surface covering of claim 1 wherein the base material layer is comprised of at least one of a vinyl material, a plastic material, a paper material and a cloth material.

4. The removable surface covering of claim 1 wherein the transparent vinyl layer is comprised of polyvinyl chloride.

5. The removable surface covering of claim 1 wherein the textured paint-like surface has a texture that is at least one of a spray-paint texture, a brushed-paint texture, a rolled-paint texture, a spackle texture, a knit texture and a powder-coated texture.

6. The removable surface covering of claim 1 wherein the base material layer has a thickness that is greater than 0.08 mm.

7. The removable surface covering of claim 1 wherein the base material layer has a thickness of approximately 0.12 mm.

8. The removable surface covering of claim 1 having a thickness of approximately 0.15 mm plus manufacturing variances of +/−0.03 mm.

9. The removable surface covering of claim 1 wherein the base material layer is comprised of a white-colored material when the applied colored ink is a lighter colored ink.

10. The removable surface covering of claim 1 wherein the base material layer is comprised of a black-colored material when the applied colored ink is a darker colored ink.

11. The removable surface covering of claim 10 wherein the darker colored ink is at least one of a dark red color and a dark blue color.

12. A method of making a removable surface covering, the method comprising:
applying a colored ink to a first surface of a base material;
laminating a transparent vinyl layer onto the first surface of the base material to produce an interim sub-assembly;
transferring a visual paint-like texture onto the laminated transparent vinyl layer of the interim sub-assembly; and
applying a pressure-sensitive adhesive layer between a second surface of the base material in the interim sub-assembly and a release layer, the release layer capable of having one or more shapes and patterns printed thereon for cutting and/or trimming, the paper being at least one of a wax-paper, a non-stick paper and a release-paper.

13. The method of claim 12 wherein the applying of the pressure-sensitive adhesive layer includes applying a water-based acrylic having a thickness range from 0.02 mm to 0.04 mm.

14. The method of claim 12 wherein the transferring of the visual paint-like texture onto the laminated transparent vinyl layer includes rolling the interim sub-assembly through one or more extruders.

15. The method of claim 14 wherein the transferring of the visual paint-like texture includes using each of the one or more extruders to apply onto the laminated vinyl layer at least one of a spray-paint texture, a brushed-paint texture, a rolled-paint texture, a spackle texture, a knit texture and a powder-coated texture.

16. The method of claim 12 wherein the applying of the colored ink includes applying a lighter colored ink when the base material is white in color.

17. The method of claim 12 wherein the applying of the colored ink includes applying a darker colored ink when the base material is black in color, the darker colored ink being at least one of a dark red color and a dark blue color.
